(19) United States
(12) Patent Application Publication
(10) Pub. No.: US 2026/0328160 A1
(43) Pub. Date: Oct. 22, 2026

(54) AIR TURBOROCKET WITH AN OPTIMIZED AIR-MIXER

(71) Applicant: DESTINUS SA, Payerne (CH)

(72) Inventors: Tristan FULLER, Taufkirchen (DE); Ambara BERNABEU VAZQUEZ, Corcelles-près-Payerne (CH); Mikhail KOKORICH, Grandvaux (CH)

(21) Appl. No.: 19/099,429

(22) PCT Filed: Sep. 8, 2022
(86) PCT No.: PCT/EP2022/074938

§ 371 Date: Jan. 28, 2025

(51) Int. Cl. F02K 1/38; F02K 9/78

(52) U.S. Cl. CPC F02K 1/386; F02K 9/78; F05D 2220/323

(57) ABSTRACT

An air turborocket engine (10), comprises a fuel tank (14), in particular comprising hydrogen, a main combustion chamber (19), a turbine (18), a compressor (21), and a first inlet opening (23) for feeding air into the main combustion chamber (19). Furthermore, the air turborocket engine (10) comprises a plurality of second inlet openings (27) for feeding fluid flowing from the turbine (18) into the main combustion chamber (19).

### TECHNICAL FIELD

The invention relates to an air turborocket engine. The air turborocket engine comprises a fuel tank, in particular comprising hydrogen, a turbine, a compressor and a main combustion chamber. A gas generator produces high pressure gas that drives the turbine. The turbine is mechanically connected with the compressor which compresses atmospheric air into the main combustion chamber. The effluent from the turbine and the compressed atmospheric air are mixed and combusted inside the main combustion chamber. The heated gas leaves the air turborocket engine through a nozzle and creates thrust.

### BACKGROUND ART

Air turborockets have an increased specific impulse over that of a rocket. For the same carried mass of propellants as a rocket motor, the overall output of the air turborocket is much higher. The air turborocket combines elements of a jet engine and a rocket. Cooling the engine is not a problem since the main combustion chamber and its hot exhaust gases are located behind the turbine blades.

The air turborocket can operate from sea level up to a certain altitude, e.g. up to 25 km altitude depending on the density of air, but not in space.

A challenge is to optimally mix the atmospheric air with the fluid flowing from the turbine into the main combustion chamber. The better the mixing the more efficient is the combustion within the main combustion chamber.

### DISCLOSURE OF THE INVENTION

The problem to be solved by the invention is the inefficiency of a non-optimized mixing of the turbine and compressor flows which leads to inefficient combustion in the main chamber and poor performance of the air turborocket.

This problem is solved by the subject of the independent claim. According to this, an air turborocket engine comprises a fuel tank, a main combustion chamber, a turbine and a compressor. In particular, the fuel tank comprises hydrogen. Air flows through a first inlet opening into the main combustion chamber. The fluid from the turbine flows through a plurality of second inlet openings into the main combustion chamber. Both flows are mixed inside the main combustion chamber and burned.

Pushing the fluid from the turbine through a plurality of smaller openings increases the mixing efficiency inside the main combustion chamber and the fluid is injected from the turbine into the main combustion chamber more precisely.

In particular, the air turborocket comprises a duct guiding the fluid flowing from the turbine into the main combustion chamber. The duct is adjacent to the turbine and adjacent to the main combustion chamber. The fluid leaving the turbine enters the duct, flows through it and leaves the duct through the plurality of second inlet openings. The duct makes it possible that fluid flowing from the turbine into the main combustion chamber is guided and flows through the plurality of second inlet openings.

Advantageously, the duct comprises a lateral surface inclined by an angle of at least 15°, in particular at least 20°, in particular at least 30°, in particular at least 40°, with respect to the axial axis of the air turborocket. Preferably, the plurality of second inlet openings is arranged on the inclined lateral surface.

The inclination of the lateral surface allows an injection of fluid from the turbine into the main combustion chamber generating a good mixture inside the main combustion chamber without compromising the inner wall of the main combustion chamber due to the high heat of the burned mixture. An injection in axial direction would fail a good mixture and an injection in radial direction would damage the inner wall of the combustion chamber.

In embodiments, the duct comprises a first section adjacent to the turbine and no openings are arranged on the first section. I.e., the fluid from the turbine flows through the first section of the duct and leaves the duct through the second inlet opening only downstream of the first section. The first section has a minimal axial length of 1/10, in particular ⅛, in particular ⅕, in particular ¼ of the total axial length of the duct. The minimal length of the duct allows the fluid to be guided first through the duct so as to be better distributed when flowing through the second inlet openings.

Advantageously, the first section is parallel to the axial axis of the air turborocket. I.e. the diameter of the duct does not change along the first section of the duct.

In embodiments, openings are only arranged on the duct, where the duct has a diameter smaller than 6/7, in particular smaller than ⅚, in particular smaller than ⅘, of the diameter of the inner wall of the main combustion chamber at the same point along the axial axis. Such a duct design prevents the arrangement of second inlet openings too close to the inner wall of the main combustion chamber. Damage of the main combustion chamber is avoided when burning the mixture.

Preferably, the duct has the form of a cone, wherein the cone comprises a base and a lateral surface. The base is adjacent to the turbine, i.e. the diameter of the duct is smaller the more spaced from the turbine.

In particular, the cone is a rounded cone or a pointed cone. Second inlet openings might be arranged on the rounded end of the cone. Alternatively, the rounded or pointed cone might not comprise any openings.

Advantageously, the second inlet openings are arranged on the lateral surface of the cone. In particular, the cone has a circular base adjoining the turbine.

Preferably, the second inlet openings have a diameter of maximally 15 mm, in particular 10 mm, in particular 7 mm, in particular 5 mm, in particular 4 mm, in particular wherein the second inlet openings are circular holes. A plurality of small inlet openings generate a better mixture of the atmospheric air and the fluid flowing from the turbine into the combustion chamber.

In preferred embodiments, the second inlet openings comprise openings with at least two different diameters. Varying the diameter makes it possible to precisely guide the fluid flowing from the turbine into the combustion chamber. E.g. openings with a larger diameter allow a fluid inlet with a higher volume flow, and openings with a smaller diameter improve the mixture of the fluid inside the combustion chamber.

Advantageously, the fluid flows from the turbine into the main combustion chamber only through the second inlet openings. No other openings for guiding fluid into the main combustion chamber are arranged on the duct which allows a precisely controlled mixture of the fluid flowing.

In embodiments, deflecting elements are arranged at the inner wall of the main combustion chamber in order to deflect the mixture of the air and the fluid flowing from the turbine to the central part of the main combustion chamber. Such a design avoids a damage of the inner wall of the combustion chamber by keeping heat away from the inner wall of the combustion chamber.

Advantageously, the first inlet opening for feeding atmospheric air into the main combustion chamber is annular. In particular, the annular opening surrounds the turbine.

In particular, the air turborocket engine might be part of an aircraft.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1a shows an air turborocket engine according to the invention in a schematic way;

FIG. 1b a detailed view of the air mixer of the air turborocket engine shown in FIG. 1a;

FIG. 2a shows an alternative air mixer in side view;

FIG. 2b shows the alternative air mixer in front view; and

FIG. 2c shows a sectional view of the alternative air mixer.

### MODES FOR CARRYING OUT THE INVENTION

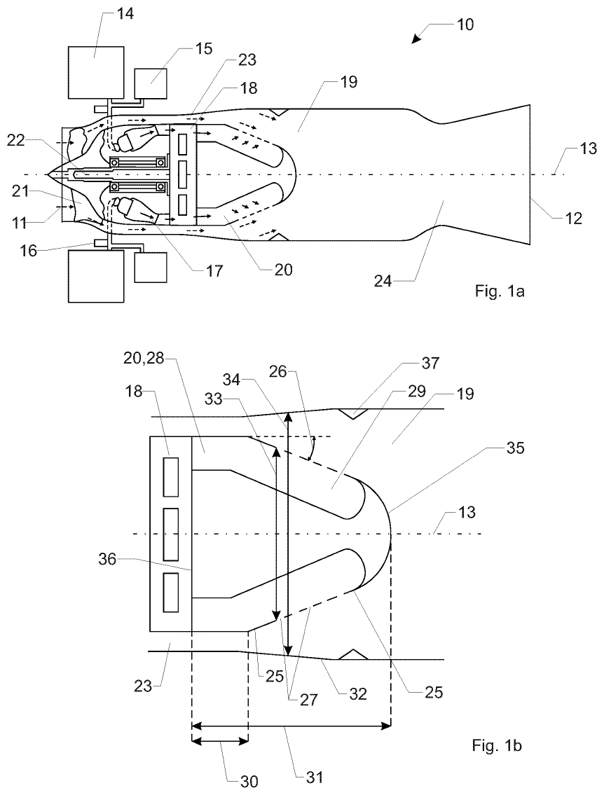

FIG. 1 shows an air turborocket engine 10 according to the invention. An aircraft can comprise such an air turborocket engine 10 and operate from sea level up to an altitude of 25 km, for example. The aircraft might operate efficiently with a speed up to Mach 5.

The air turborocket engine 10 has a first end 11 and a second end 12. The thrust of the air turborocket engine 10 is directed from the second end 12 along the axial axis 13 of the air turborocket engine 10.

Hydrogen in liquid form or in compressed gas form is stored in first tanks 14 and oxygen is stored in second tanks 15. Pumping means 16 pump the hydrogen and the oxygen into precombustors 17. All of the hydrogen is fed to the precombustors 17 but the precombustors 17 receive only enough oxygen to raise its efflux temperature to a level that can be tolerated by the turbine 18. The hydrogen rich effluent from the turbine 18, comprising water vapor, is fed to a main combustion chamber 19 via a duct 20. The flow of hydrogen is illustrated by solid arrows. For example, a mass flow of 0.25 kg/s leaves the turbine.

The turbine 18, driven by the hydrogen rich mixture that leaves the precombustors, transmits power to a compressor 21 via a drive shaft 22. The compressor 21 compresses atmospheric air entering into the air turborocket engine from outside. The compressed air is guided through an annular first inlet opening 23 into the main combustion chamber 19. The annular first inlet opening 23 surrounds the turbine 18. The atmospheric air and the effluent from the turbine 18 are mixed inside the main combustion chamber 19 and provide a mixture to be burned. Inside the main combustion chamber, very high temperatures exist normally associated with rocket engines. The flow of atmospheric air is illustrated by dashed arrows.

The combusted mixture leaves the air turborocket engine 10 through a convergent-divergent propelling nozzle 24 and creates thrust with a mass flow of 4.4 kg/s, for example. Nozzle 24 and duct 20 are made of a heat resistant material well known to the person skilled in the art working in aerospace engineering.

FIG. 1b shows the duct 20 in a more detailed view. The duct 20 comprises a lateral surface 25 which is inclined by an angle 26 of at least 20° with respect to the axial axis 13 of the air turborocket 10. A plurality of second inlet openings 27 are arranged on the inclined lateral surface 25. The second inlet openings 27 have a diameter of 5 mm. Alternatively, the plurality of second inlet openings 27 comprises openings with different sizes, e.g. openings with a size of 10 mm and openings with a size of 5 mm.

The duct 20 comprises a first section 28 adjoining the turbine 18 and a second section 29 adjoining the first section 28. The first section 28 has an axial length 30 of ⅓ of the total axial length 31 of the duct 20. The first section 28 is parallel to the axial axis 13 of the air turborocket.

No openings are arranged on the first section 28, i.e. no effluent from the turbine 18 leaves the duct 20 along the first section 28. The effluent only leaves the duct 20 into the main combustion chamber 19 along the second section 29. No openings are arranged on the rounded end 35 of the duct 20.

In order to protect the inner wall 32 of the combustion chamber 19, second inlet openings 27 are only arranged on the lateral surface 25 with a certain distance to the inner wall 32. Second inlet openings 27 are only arranged on the duct 20 where the diameter 33 of the duct 20 is smaller than ⅚ of the diameter 34 of the inner wall 32.

The inclination of the lateral surface 25 and the plurality of second inlet openings 27 with a small diameter create a good mixture inside the main combustion chamber 19. Furthermore, the flame is located inside the main combustion chamber 19 so that neither the inner wall 32 of the combustion chamber 19 nor the duct 20 are damaged by the high temperature of the flame. The flame is positioned inside the main combustion chamber 19 such that the flame is sufficiently spaced from the inner wall 32 and from the duct 20.

The duct 20 has the form of a cone. The cone has a circular base 36 adjoining the turbine 18, a lateral surface 25 and a rounded end 35.

Deflecting elements 37 are arranged on the inner wall 32 of the main combustion chamber 19. The deflecting elements 37 deflect the atmospheric air and/or the mixture to the central part of the main combustion chamber 19, i.e. in the direction of the axial axis 13.

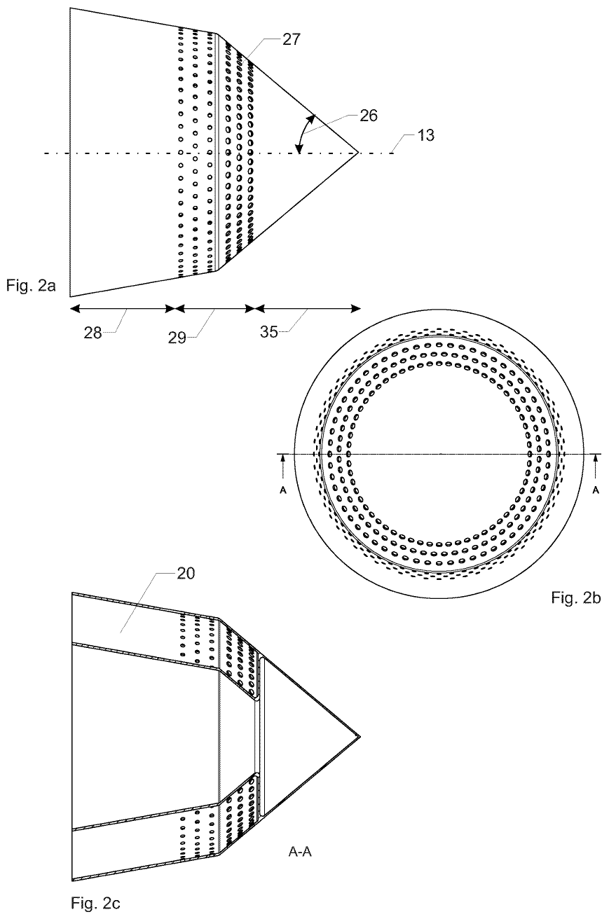

FIGS. 2a, 2b and 2c show an alternative duct 20. FIG. 2a shows a side view, FIG. 2b a front view and FIG. 2c a sectional view of the duct 20. The section line of the sectional view of FIG. 2c is shown in FIG. 2b and referenced by A-A.

Again, the duct 20 comprises a first section 28 without any openings and a second section 29 with a plurality of second inlet openings 27. The duct 20 has the form of a cone with a pointed end 35. The lateral surface 25 of the duct is inclined with an angle 26 of 40°.

All second inlet openings 27 have an identical diameter of 2.7 mm and are spread around the full perimeter of the duct 20. The duct 20 is axisymmetric.

1. Air turborocket engine, comprising:
a fuel tank, in particular comprising hydrogen,
a main combustion chamber,
a turbine,
a compressor,
a first inlet opening for feeding air into the main combustion chamber, characterized in that
the air turborocket engine comprises a plurality of second inlet openings for feeding fluid flowing from the turbine into the main combustion chamber.

2. Air turborocket engine according to claim 1, wherein the air turborocket engine comprises a duct guiding the fluid flowing from the turbine into the main combustion chamber.

3. Air turborocket engine according to claim 2, wherein the duct comprises a lateral surface inclined by an angle of at least 15°, in particular at least 20°, in particular at least 30°, in particular at least 40°, with respect to the axial axis of the air turborocket engine.

4. Air turborocket engine according to claim 3, wherein the plurality of second inlet openings is arranged on the inclined lateral surface.

5. Air turborocket engine according to claim 2, wherein the duct comprises a first section adjoining the turbine, no openings are arranged on the first section and the first section has a minimal axial length of 1/10, in particular ⅛, in particular ⅕, in particular ¼ of the total axial length of the duct,
in particular wherein the first section is parallel to the axial axis of the air turborocket engine.

6. Air turborocket engine according to claim 2, wherein openings are only arranged on the duct, where the duct has a diameter smaller than 6/7, in particular smaller than ⅚, in particular smaller than ⅘, of the diameter of the main combustion chamber at the same point along the axial axis.

7. Air turborocket engine according to claim 2, wherein the duct has the form of a cone, wherein the cone comprises a base and a lateral surface.

8. Air turborocket engine according to claim 7, wherein the cone is a rounded cone or a pointed cone.

9. Air turborocket engine according to claim 7, wherein the second inlet openings are arranged on the lateral surface of the cone.

10. Air turborocket engine according to claim 7, wherein the cone has a circular base adjoining the turbine.

11. Air turborocket engine according to claim 1, wherein the second inlet openings have a diameter of maximally 15 mm, in particular 10 mm, in particular 7 mm, in particular 5 mm, in particular 4 mm, in particular wherein the second inlet openings a circular holes.

12. Air turborocket engine according to claim 1, wherein the second inlet openings comprise openings with at least two different diameters.

13. Air turborocket engine according to claim 1, wherein the fluid flows from the turbine into the main combustion chamber only through the second inlet openings.

14. Air turborocket engine according to claim 1, wherein deflecting elements are arranged at the inner wall of the main combustion chamber in order to deflect the mixture of the air and the fluid from the turbine to the central part of the main combustion chamber.

15. Air turborocket engine according to claim 1, wherein the first inlet opening is annular.

16. Aircraft comprising an air turborocket engine according to claim 1.
